(19) United States
(12) Patent Application Publication
(10) Pub. No.: US 2005/0174608 A1
(43) Pub. Date: Aug. 11, 2005

(54) Method for blocking facsimile transmissions to non-fax devices

(76) Inventors: Peggy Hasan, Aurora, IL (US); Sandra Lynn True, St. Charles, IL (US)

Correspondence Address: Docket Administrator (Room 3J-219);Lucent Technologies Inc., 101 Crawfords Corner Road, Holmdel, NJ, 07733-3030, US

(21) Appl. No.: 10/761,069

(22) Filed: Jan. 20, 2004

(51) Int. Cl. H04N 1/00; H04M 11/00; H04Q 7/20; H04Q 7/22

(52) U.S. Cl. 358/407; 358/434; 358/437; 379/100.05; 379/100.06; 379/100.15; 358/440; 455/432.3; 455/433

(57) ABSTRACT

Methods are disclosed for blocking fax transmissions to non-fax devices. When a fax call request is received from an originating fax device, it is determined whether the called party device is eligible to receive the fax transmission. If the called party device is not eligible to receive the fax transmission, the fax call request is blocked thereby causing the called party device not to receive the fax transmission and an error message may be sent to the originating fax device. If the called party device is eligible to receive the fax transmission, the fax call request is completed thereby enabling the called party device to receive the fax transmission.

### FIELD OF THE INVENTION

This invention relates generally to the field of telecommunication systems and, more particularly, to a method for blocking facsimile transmissions to devices that are incapable of decoding such transmissions.

### BACKGROUND OF THE INVENTION

Communication systems are well known in which persons may send and receive facsimile transmissions (“faxes”) between suitably equipped communication devices such as, for example and not limitation, fax machines or fax modems (hereinafter “fax devices”). Typically, a fax device implements a fax transmission by encoding information associated with a document into a sequence of tones, calling a directory number associated with a receiving device and, if the call is answered, sending the tone sequence to the receiving device. If the receiving device is a fax device, the receiving device is operable to decode the transmission and reconstruct a facsimile of the original document.

A problem that arises is fax transmissions are often attempted to devices that are not equipped to decode the tone sequence (“non-fax devices”). These devices may comprise, for example, wireless or wireline phones adapted for human voice communications. Traditionally, when this occurs, the network does not recognize the call as containing a fax transmission or that the recipient will be unable to decode the transmission. Hence, the network connects the call in conventional fashion by ringing the called party device and, if the call is answered, a fax tone sequence is played to the recipient party. Generally, persons do not wish to receive such calls because fax tone sequences are unintelligible and unpleasant to the human ear. Adding insult to injury, many fax devices are programmed to repeatedly reattempt fax transmissions so even if a person does not answer a call originating from a fax device, the person must endure repeated ringing of the called party device coincident to the reattempted fax transmissions.

Accordingly, there is a need for a method of blocking fax transmissions to devices that are not equipped to decode fax transmissions. Advantageously, such blocking will occur without ringing of the called party device. The present invention is directed to addressing this need.

### SUMMARY OF THE INVENTION

This need is addressed and a technical advance is achieved in the art by a feature whereby a network device can block fax transmissions to a called party device that is determined to be a non-fax device.

In one embodiment, there is provided a method whereby a fax call request is received from an originating fax device, the fax call request defining a request for fax transmission to a called party device. A determination is made whether the called party device is eligible to receive the fax transmission. If the called party device is determined not to be eligible to receive the fax transmission, the fax call request is blocked thereby causing the called party device not to receive the fax transmission. The fax call request may be blocked prior to ringing the called party device and an error message may be sent to the originating fax device. If the called party device is eligible to receive the fax transmission, the fax call request is completed thereby enabling the called party device to receive the fax transmission.

In another embodiment, there is provided a method whereby a call request is received from an originating device. A determination is made whether the call request is a fax call request, the fax call request defining a request for fax transmission to a called party device; and a determination is made whether the called party device is a fax device. If the call request is a fax call request and the called party device is not a fax device, the call request is blocked thereby causing the called party device not to receive the fax transmission. The call request may be blocked prior to ringing the called party device and an error message may be sent to the originating fax device. If the called party device is eligible to receive the fax transmission, the fax call request is completed thereby enabling the called party device to receive the fax transmission.

### BRIEF DESCRIPTION OF THE DRAWINGS

The foregoing and other advantages of the invention will become apparent upon reading the following detailed description and upon reference to the drawings in which:

FIG. 1 is a block diagram of a communication system in which embodiments of the present invention may be implemented; and

FIG. 2 is a flowchart of a method for blocking fax transmissions to non-fax devices according to an embodiment of the present invention.

### DESCRIPTION OF THE PREFERRED EMBODIMENT(S)

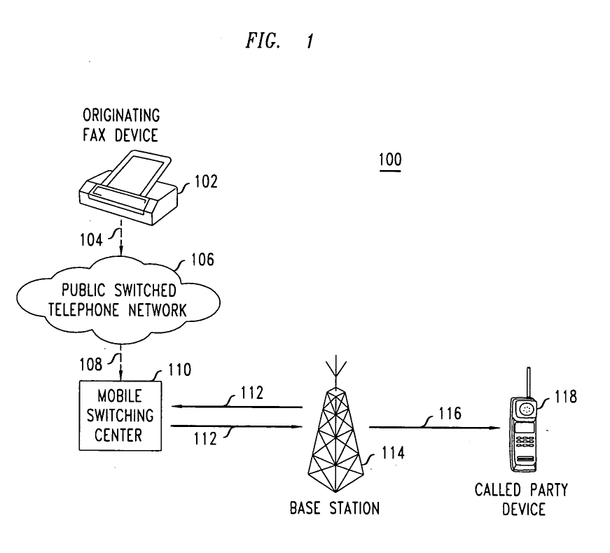

FIG. 1 shows a communication system 100 operable to support fax transmissions from an originating fax device 102 to a called party device 118. The originating fax device 102 is a fax machine connected by link 104 to a network 106 (as shown, the Public Switched Telephone Network (PSTN)). The network 106 is connected by link 108 to a switching element 110 (as shown, a mobile switching center (MSC)). The switching element 110, in turn, is connected by links 112 to a base station 114. The base station 114 is connected by wireless link 116 to the called party device 118 (as shown, a mobile unit).

The communication system 100 is shown by way of example and not limitation. The originating fax device 102 may comprise a fax machine, wireless or wireline phone, personal digital assistant (PDA), personal computer or generally any device capable of sending fax transmissions. The network 106 may be implemented using any appropriate transmission, switching and routing technologies, including but not limited to Internet Protocol (IP) and Asynchronous Transfer Mode (ATM) technologies. The switching element 110 may comprise, for example, a mobile switching center or central office switch. As will be appreciated, the switching element 110 is a functional element that may reside in a single switch or may be distributed among multiple switches and/or locations. The called party device 118 may comprise a fax machine, wireless or wireline phone, personal digital assistant (PDA), personal computer or generally any device that may be the intended recipient of a call from an originating fax device. The called party device may or may not be a fax device that is capable of decoding fax transmissions. According to embodiments of the invention, the communication system 100 is operable to determine if the called party device is a fax device and either support or block fax transmissions to the called party, as the case may be, depending on whether the called party device is a fax device.

As shown, the called party device 118 comprises a mobile unit (e.g., a mobile phone) served by base station 114 and the switching element 110 is a mobile switching center MSC. The mobile unit 118, generally, is adapted to roam between different RF coverage areas, sometimes referred to as “cells” (not shown) served by a plurality of base stations 114. Wireless calls to the mobile unit 118 are communicated via RF resources 116 from the base station 114. The RF resources 116 may implement air interface technologies including but not limited to, CDMA, TDMA, GSM, UMTS or IEEE 802.11.

The MSC 110 is a call processing control entity that routes calls, including fax transmissions, as may be appropriate, from the network 106 to the mobile unit 118. The MSC 110 may comprise, for example, an AUTOPLEX™ switching system, available from Lucent Technologies, Inc. The MSC 110 includes a memory and processor (not shown), for storing and executing software routines for processing and switching calls and for providing various call features to calling or called parties. Typically, the MSC 110 further includes home location register (HLR) and visitor location register (VLR) functionality to monitor the location of mobile units as they roam between different cell sites or between different service areas controlled by different MSCs. The MSC 110 may be configured for operation with generally any suitable circuit, cell, or packet switching technology.

As will appreciated, in embodiments where the called party device 118 is a wireline device it will receive calls via wireline links (not shown) comprising, for example, conventional subscriber lines, ISDN lines, Ethernet LAN, and the like; and the switching element 110 may comprise a central office switch (not shown). The central office switch may comprise, for example, a 5ESS® switching system, available from Lucent Technologies, Inc. Generally, similarly to an MSC, a central office switch includes a memory and processor for storing and executing software routines for processing and switching calls and for providing various call features to calling or called parties except it does not include HLR/VILR functionality.

In one embodiment, the MSC 110 upon receiving a fax call request (e.g., from originating fax device 102) determines a directory number of the called party device and consults a database (not shown) to determine if the called party directory number corresponds to a fax device that is capable of decoding fax transmissions. The database may reside within the MSC 110 or external to the MSC. The database advantageously includes a plurality of records identifying various directory numbers and “flags” or other indicators identifying which directory numbers correspond to fax devices (or alternatively, identifying which directory numbers do not correspond to fax devices). It is contemplated that the database entries (i.e., indicating whether a directory number is associated with a fax device or non-fax device) may be made at time of service provisioning of the device; or perhaps the database entries may be made upon subscription of a device to a “fax blocking” service.

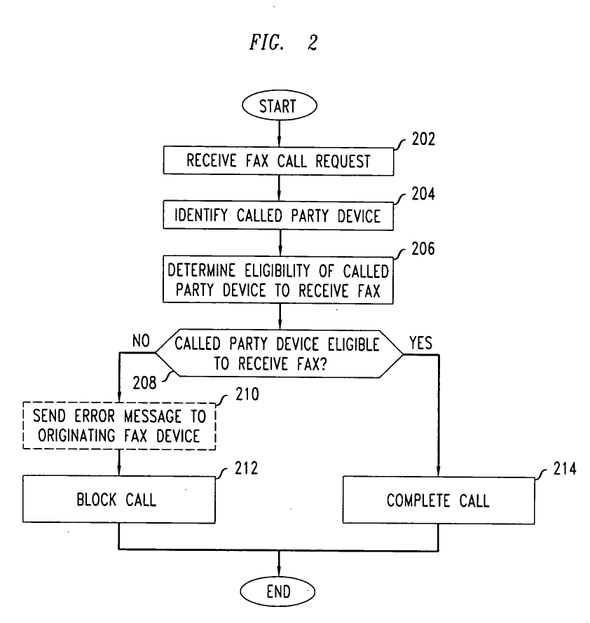

In one embodiment, as will be described in greater detail in relation to FIG. 2, the MSC 110 after determining whether the called party device is a fax device will complete the call if the called party device is a fax device or block the call if the called party device is not a fax device. Additionally, the MSC may also consult the database upon receiving a call request to determine whether the call request is from an originating fax device (and hence a fax call request) or from a non-fax device. In one embodiment, this determination is made by the MSC determining a directory number of the calling device and consulting the database to determine if the directory number of the calling device corresponds to a fax device.

Turning now to FIG. 2, there is shown a flowchart of a method that may be implemented for blocking fax transmissions to non-fax devices. The steps of FIG. 2 are implemented, in one embodiment, using stored software routines within a switching element (e.g., MSC 110) processing various call requests including fax call requests. The method presumes an originating fax device (e.g., originating fax device 102) dials a directory number of a called party device (e.g., mobile unit 118) to initiate a fax call request directed to the called party device.

At step 202, the MSC 110 receives the fax call request. The method presumes that the MSC 110 not only receives the fax call request but also is able to recognize the call request as a fax call request (as opposed to a conventional call request). For example, in one embodiment, the MSC 110 upon receiving the call request may identify the directory number of the originating fax device, consult a database to determine that the directory number of the calling device corresponds to a fax device, and thus identify the call request as a fax call request. At step 204, the MSC 110 identifies the called party device that is the intended recipient of the fax call request. In one embodiment, step 204 comprises the MSC 110 identifying the directory number of the called party device (contained within the call request) and in such case steps 202 and 204 are performed substantially concurrently.

At step 206, the MSC 110 determines the eligibility of the called party device to receive fax transmissions. In one embodiment, a positive determination of 1o eligibility is made at step 206 if the called party device is determined to be a fax device. In one embodiment, the MSC 110, following identification of the directory number of the called party device, consults a database to determine whether the directory number of the called party device corresponds to a fax device. If the directory number corresponds to a fax device, the called party device is a fax device eligible to receive and decode fax transmissions and a positive determination of eligibility is made at step 206. Conversely, if the directory number does not correspond to a fax device, a negative determination of eligibility is made at step 206.

Alternatively or additionally, a determination of eligibility at step 206 may be made based on user preferences, subscription status or like information stored in the database. For example, a negative determination of eligibility could be made at step 206 for a fax device if the user prefers not to receive fax transmissions and this preference is recorded in the database. As another example, a positive determination of eligibility could be made at step 206 for non-fax devices if the user does not subscribe to a fax blocking service or if the subscriber's account balance is insufficient or not paid up for a period of time. As still another alternative, a determination of eligibility at step 206 may be made based on the user affirmatively “accepting” or “rejecting” the call request. For example, a message may be played or displayed to a user of a called party device coincident to a fax call request prompting the user to accept or reject the call request and the determination of eligibility made accordingly based on the user's response.

At decision block 208, the method takes one of two paths depending on whether a positive or negative determination of eligibility was made at step 206. If a negative determination of eligibility was made (e.g., the called party device is not a fax device), an error message is sent to the originating fax device at step 210. Step 210 is indicated as optional. If performed, step 210 serves the purpose of informing the originating fax device that the intended recipient is ineligible to receive faxes and, accordingly, the originating fax device knows not to re-attempt fax transmissions to the called party device. At step 212, the call is blocked, that is the requested fax transmission is not completed to the called party device. In the preferred embodiment, the step of blocking the call at step 212 is performed prior to ringing the called party device such that the called party device does not ring for attempted fax transmissions. If a positive determination of eligibility was made at step 206 (e.g., the called party device is a fax device), the call is completed at step 214 thereby enabling the fax device to receive the fax transmission.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. A method comprising the steps of:
receiving a fax call request from an originating fax device, the fax call request defining a request for fax transmission to a called party device;
determining an eligibility of the called party device to receive the fax transmission; and
if the called party device is determined not to be eligible to receive the fax transmission, blocking the fax call request thereby causing the called party device not to receive the fax transmission.

2. The method of claim 1, wherein the step of blocking the fax call request is accomplished prior to ringing of the called party device.

3. The method of claim 1, further comprising:
if the called party device is determined not to be eligible to receive the fax transmission, sending an error message to the originating fax device.

4. The method of claim 1, further comprising:
if the called party device is determined to be eligible to receive the fax transmission, completing the fax call request, thereby enabling the called party device to receive the fax transmission.

5. The method of claim 1, wherein the step of determining an eligibility of the called party device to receive the fax transmission comprises;
determining whether the called party device is a fax device, a positive determination of eligibility being made if the called party is a fax device.

6. The method of claim 1, wherein the step of determining whether the called party device is a fax device comprises:
identifying a directory number of the called party device;
consulting a database of directory numbers to determine if the directory number of the called party device corresponds to a fax device, a positive determination of eligibility being made if the directory number of the called party device corresponds to a fax device.

7. A method comprising the steps of:
receiving a call request from an originating device;
determining whether the call request is a fax call request, the fax call request defining a request for fax transmission to a called party device;
determining whether the called party device is a fax device; and
if the call request is a fax call request and the called party device is not a fax device, blocking the call request thereby causing the called party device not to receive the fax transmission.

8. The method of claim 7, wherein the step of blocking the fax call request is accomplished prior to ringing of the called party device.

9. The method of claim 7, further comprising:
if the called party device is determined not to be eligible to receive the fax transmission, sending an error message to the originating fax device.

10. The method of claim 7, further comprising:
if the call request is a fax call request and the called party device is a fax device, completing the fax call request thereby enabling the called party device to receive the fax transmission.

11. The method of claim 7, wherein the step of determining whether the call request is a fax request comprises:
identifying a directory number of the originating device;
consulting a database of directory numbers to determine if the directory number of the originating device corresponds to a fax device, the call request being determined to be a fax request if the directory number of the originating device corresponds to a fax device.
